(19) United States
(12) Patent Application Publication
(10) Pub. No.: US 2003/0120581 A1
(43) Pub. Date: Jun. 26, 2003

(54) System and method for facilitating securites borrowing transactions

(76) Inventors: Janat Horn, Brooklyn, NY (US); Edward Vakhovsky, Brooklyn, NY (US); Irina Idislavovna Nesterovich, Fair Lawn, NJ (US); Amiran Margalitachvili, Bronx, NY (US)

Correspondence Address: Leslie Gladstone Restaino, Esq., Brown Raysman Millstein Felder & Steiner LLP, 4th Floor, 55 Madison Avenue, Morristown, NJ, 07960, US

(21) Appl. No.: 10/026,747

(22) Filed: Dec. 20, 2001

(51) Int. Cl. G06F 17/60

(52) U.S. Cl. 705/37

(57) ABSTRACT

The present invention discloses a system and method for facilitating securities borrowing transactions. A securities borrow request is securely transmitted over a network from a first computer to a server computer. The server computer evaluates the request based upon stored criteria data, including availability data associated with the requested securities, to attempt to generate an approval determination. The status of the approval determination is transmitted to the first computer. If no approval determination can be generated based upon the evaluation, the server computer transmits the request to a second computer, where a manual approval determination is made, entered into the second computer, and transmitted to the first computer. The availability data is updated to reflect any decrease in securities availability resulting from any approved borrow request.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates to financial business systems; and more particularly, to a system and method for facilitating securities borrowing transactions.

2. Description of the Related Art

Certain financial transactions involve the borrowing of securities, such as stocks. One example of such a transaction is a “selling short” transaction, or “short sale” in which an investor attempts to take advantage of an anticipated decline in stock price. Herein, the term “transaction” is used broadly to represent various financial dealings and groups of associated dealings. The following is a simplified example of a selling short transaction. Buyer A indicates to broker B that buyer A is interested in purchasing 100 shares of XYZ stock at $100 per share. Broker B anticipates an impending decline in the price of XYZ stock. Broker B borrows 100 shares of XYZ stock from company A, to sell to buyer A. Company A charges an interest rate on the value of the loan to Broker B. Broker B must, at some future time, return 100 shares of XYZ stock to company A to fulfill the loan obligation. Two weeks later, Broker B purchases 100 shares of XYZ stock at $90 per share. Thus, broker B, having sold 100 shares of XYZ stock for $10,000, purchases 100 shares of XYZ stock for $9,000 to return to Company A.

From the foregoing transaction, broker B may make a profit of $1,000 less broker B's expenses associated with the transaction, which include Broker B's interest obligation to company A. Broker B can then, of course, pass the profit on to buyer A. Broker B's ability to have a securities borrow request approved by company A as quickly and efficiently as possible may be crucial to making the transaction possible. For example, buyer A may lose interest shortly after offering to purchase the shares, whether because the purchase price for the shares rises or for other reasons. Moreover, where company A can provide cost-effective services to broker B, company A can offer a lower interest rate to broker B while still making an acceptable profit, and broker B is more likely to be able to profitably enter into the transaction or to utilize the services of company A in borrowing the stocks. In addition, broker B naturally has an important interest that broker B's dealings with company A will be safe and secure.

Various computerized systems for providing financial services and for facilitating financial transactions are known in the art. U.S. Pat. No. 6,304,858 issued on Oct. 16, 2001 to Mosler et al. discloses a computer-implemented system for trading in which a standardized contract is traded. The contact obligates a buyer and a seller to settle the contract based on a price of the contract at a first effective date. The contract is traded through an exchange, and a price of the contract is determined from certain financial factors. U.S. Pat. No. 6,014,643 issued on Jan. 11, 2000 to Mosler et al. discloses an interactive securities trading system. Sellers and buyers of securities may transact through the system. Upon acceptance by a buyer of a seller's offer, the buyer's account is debited and the buyer receives title to the purchased securities. Published International application WO 01/09699, published on Feb. 8, 2001, discloses a system for estimating a price of a limit order. A server computer receives indicia identifying a security. The server computer estimates a price for an associated limit order and outputs the estimated price over a network to client computers.

In spite of the above prior art, however, there remains a need for a system for facilitating securities borrowing transactions that enables borrow requests to be processed conveniently, efficiently, quickly, securely, and cost-effectively.

### SUMMARY OF THE INVENTION

The present invention provides a system and a method for facilitating securities borrowing transactions that enables borrow requests to be processed conveniently, efficiently, quickly, securely, and cost-effectively.

In one embodiment, the invention provides a networked computer system for facilitating transactions, the transactions including borrowing of securities. The system includes a database containing securities availability data; a client computer; and a server computer, wherein the server computer receives a borrow request transmitted by the client computer; evaluates the borrow request based upon approval criteria, the approval criteria including availability of the requested securities, the availability being determined by the server computer utilizing the availability data; generates, based upon the evaluation, an approval determination; transmits to the client computer an indication of the generated approval determination; and if any portion of the securities request is determined to be approved, causes data in the database to be updated to reflect a decrease in securities availability resulting from the approval.

In another embodiment, the invention provides a networked computer system for facilitating transactions, the transactions including borrowing of securities. The system includes a database containing securities availability data; a client computer; a trading computer; and a server computer, wherein the server computer receives a borrow request transmitted by the client computer; evaluates the borrow request based upon approval criteria, the approval criteria including availability of the requested securities, the availability being determined by the server computer utilizing the availability data; if possible based upon the evaluation, generates an approval determination; transmits to the client computer an indication of the status of the approval determination; if an approval determination could not be generated for a first portion of the request based upon the approval criteria, transmits an indication to the trading computer of a pending status of the first portion, and receives from the trading computer a trading computer approval determination, the trading computer approval determination having been entered into the trading computer; and, if any portion of the securities request is determined to be approved, causes data in the database to be updated to reflect a decrease in securities availability resulting from the approval.

In yet another embodiment, the invention provides, in a networked computer system including a server computer and a client computer, a method for facilitating transactions, the transactions including borrowing of securities, the method including the client computer transmitting a securities borrow request to the server computer; the server computer receiving the borrow request and evaluating the borrow request based upon approval criteria, the approval criteria including availability of the requested securities, the availability being determined by the server computer utilizing availability data contained in a database accessed by the server computer; the server computer generating, based upon the evaluation, an approval determination; the server computer transmitting to the client computer an indication of the generated approval determination; and, if any portion of the securities request is determined to be approved, the server computer causing data in the database to be updated to reflect a decrease in securities availability resulting from the approval.

Another embodiment of the invention provides, in a networked computer system including a server computer, a client computer, and a trading computer, a method for facilitating transactions, the transactions including borrowing of securities, the method including the client computer transmitting a securities borrow request to the server computer; the server computer receiving the borrow request and evaluating the borrow request based upon approval criteria, the approval criteria including availability of the requested securities, the availability being determined by the server computer utilizing availability data contained in a database accessed by the server computer; if possible based upon the evaluation, the server computer generating an approval determination; the server computer transmitting to the client computer an indication of the status of the approval determination; if an approval determination could not be generated for a first portion of the request based upon the approval criteria, the server computer transmitting an indication to the trading computer of a pending status of the first portion, and receiving from the trading computer a trading computer approval determination, the trading computer approval determination having been entered into the trading computer; and, if any portion of the securities request is determined to be approved, the server computer causing data in the database to be updated to reflect a decrease in securities availability resulting from the approval.

A further embodiment of the invention provides a computer usable medium storing program code which, when executed on a computerized device, causes the computerized device to execute, in a networked computer system comprising a server computer, a client computer, and a trading computer, a method for facilitating transactions, the transactions including borrowing of securities, the method including the client computer transmitting a securities borrow request to the server computer; the server computer receiving the borrow request and evaluating the borrow request based upon approval criteria, the approval criteria including availability of the requested securities, the availability being determined by the server computer utilizing availability data contained in a database accessed by the server computer; if possible based upon the evaluation, the server computer generating an approval determination; the server computer transmitting to the client computer an indication of the status of the approval determination; if an approval determination could not be generated for a first portion of the request based upon the approval criteria, the server computer transmitting an indication to the trading computer of a pending status of the first portion, and receiving from the trading computer a trading computer approval determination, the trading computer approval determination having been entered into the trading computer; and, if any portion of the securities request is determined to be approved, the server computer causing data in the database to be updated to reflect a decrease in securities availability resulting from the approval.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram of a distributed computer system according to one embodiment of the invention;

FIG. 2 is a flow diagram of a method for facilitating securities borrowing transactions, according to one embodiment of the invention;

FIG. 3 is a flow diagram of a method for facilitating securities borrowing transactions, according to another embodiment of the invention;

FIG. 4 is a simplified depiction of a graphical user interface displayed on a customer client computer according to one embodiment of the invention, in which a transaction list is shown in the foreground;

FIG. 5 is a simplified depiction of a graphical user interface displayed on a customer client computer according to one embodiment of the invention, in which a security list is shown in the foreground; and

FIG. 6 is a simplified graphical user interface displayed on a customer client computer according to one embodiment of the invention, in which a transaction list and a security list file tree are shown in the foreground.

### DETAILED DESCRIPTION OF THE PREFERRED EMBODIMENT

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

The present invention generally provides a system and a method for facilitating securities borrowing transactions that enables borrow requests to be processed conveniently, efficiently, quickly, securely, and cost-effectively. Published international application, publication no. WO 01/61590, published on Aug. 23, 2001 and entitled, “System for Providing Financial Services,” hereby incorporated herein by reference in its entirety, discloses a distributed computer system, many features of which can be used in the practice of various embodiments of the present invention.

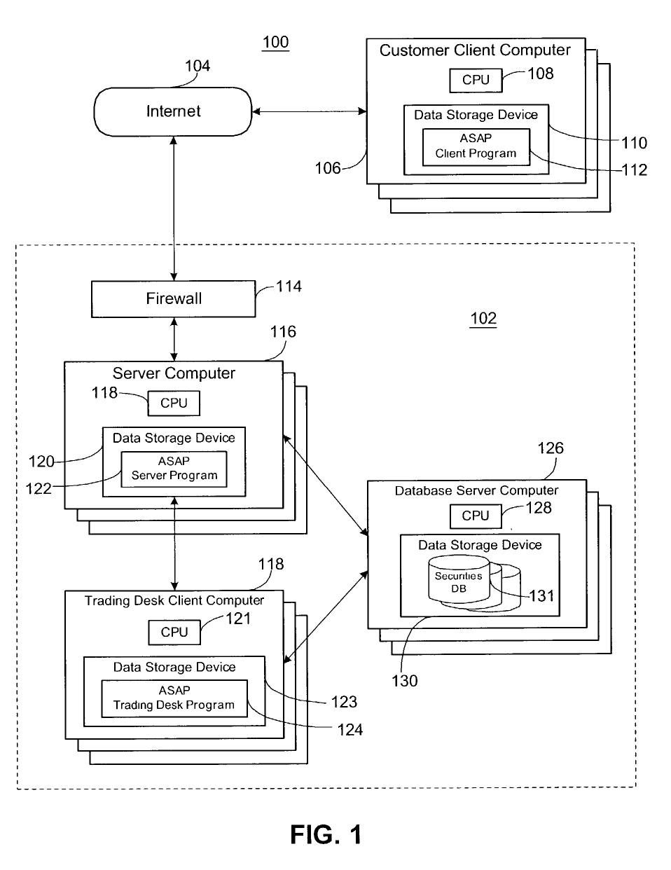

FIG. 1 is a block diagram of a distributed computer system 100 according to one embodiment of the invention. As depicted in FIG. 1, a network, such as the Internet 104, connects one or more customer client computers 106 to one or more server computers 116, the one or more server computers 116 being part of an integrated computer system 102. Although the Internet 104 is depicted, the invention contemplates embodiments in which the customer client computer 106 is connected to the server computer 116 via one or more other networks, such as LANs or WANs, and the invention contemplates embodiments in which no connection to the Internet is provided.

One or more firewalls 114 as known in the art, such as a packed filter firewall, circuit gateway firewall, application gateway firewall, or trusted gateway firewall, which may comprise various hardware and software, provides secured access to the server computer 116 and the computer system 104 from devices connected to the Internet 104 which are not part of the computer system 104. The computer system 102 also comprises one or more database server computers 126 and one or more trading desk client computers 118. In some embodiments of the invention, each of the one or more server computers 116 are themselves connected to each other via one or more LANs or WANs, and the same may be true for the one or more trading desk client computers 118 and the one or more database server computers 126. In the embodiment shown, the server computer 116, trading desk computer 118, and database server computer 126 are all connected to each other, such as through one or more local area networks (LANs) or wide area networks (WANs), or through the Internet.

In the embodiment shown, the server computer 116, the trading desk computer 118, and the database server computer 126 are separate computers; however, the invention contemplates embodiments wherein the components or functionality of these various computers 116, 118, 126 are combined into one or more computers, and embodiments in which the components and functionality of the computers 116, 118, 126 is distributed differently than as shown in FIG. 1. Additionally, in some embodiments of the invention, no trading desk client computer 118 or trading desk computer functionality is provided.

The customer client computer 106 comprises one or more Central Processing Units (CPUs) 108, and one or more data storage devices 110 which may include one or more Internet Browser programs. The server computer 116, the trading desk computer 118, and the database server computer 126 each respectively comprises one or more CPUs 118, 121, 128 and one or more data storage devices 120, 123, 130.

The data storage devices 110, 120, 123, 130 may comprise various amounts of RAM for storing computer programs and other data or databases. In addition, the computers 106, 116, 118, 126 may include other components typically found in computers, including one or more output devices such as monitors, other fixed or removable data storage devices such as hard disks, floppy disk drives and CD-ROM drives, and one or more input devices, such as mouse pointing devices and keyboards. Computers 106, 116, 118, 126 operate under and execute computer programs under the control of an operating system, such as Windows, Macintosh, UNIX, etc.

Generally, the computer programs of the present invention are tangibly embodied in a computer-readable medium, e.g., one or more data storage devices attached to a computer. Under the control of an operating system, computer programs may be loaded from data storage devices into computer RAM for subsequent execution by the CPU. The computer programs comprise instructions which, when read and executed by the computer, cause the computer to perform the steps necessary to execute elements of the present invention.

In the following description, the term automated securities approval program (ASAP) will be utilized. This term is not intended to be limiting, including not being limited to programs that only facilitate approvals, nor being limited to programs that are completely automated. Rather, the term is utilized in a broad descriptive sense to indicate programming to facilitate, or programming that provides applications that facilitate, the systems and methods of the invention, including programming to facilitate, as described in detail herein, partially or fully automated approval determinations relating to securities borrowing transactions. In addition, the ASAP term is utilized in certain names for programming to indicate that the programming is associated with ASAP functionality.

As depicted, the data storage device 110 of the client computer comprises an ASAP client program 112, the data storage device 120 of the server computer 116 comprises an ASAP server program 122, the data storage device 123 of the trading desk computer 118 comprises an ASAP trading desk program 122. Although, the embodiment depicted, the ASAP client program 112, the ASAP server program 122, and the ASAP trading desk program 118 are separate and remote from each other, in other embodiments, the programs 112, 122, 118 may be combined or integrated in various ways, or may, for example, be executed from a single computer to provide applications to be used by other computers.

The data storage device 130 of the database server computer 126 comprises one or more securities databases 131 or database systems, such as a relational database and database systems, including, for example, an Oracle® database, commercially available from Oracle® Corporation, a DB2 database, commercially available from IBM® Corporation, and a Sybase® database, commercially available from Sybase® Corporation, Microsoft® Structured Query Language (SQL) server databases, and other Open DataBase Compliant (ODBC) data sources including other SQL databases. In some embodiments of the invention, a database server computer 126 is not provided, and the one or more securities databases 131 are included in another of the computers in the computer system 102.

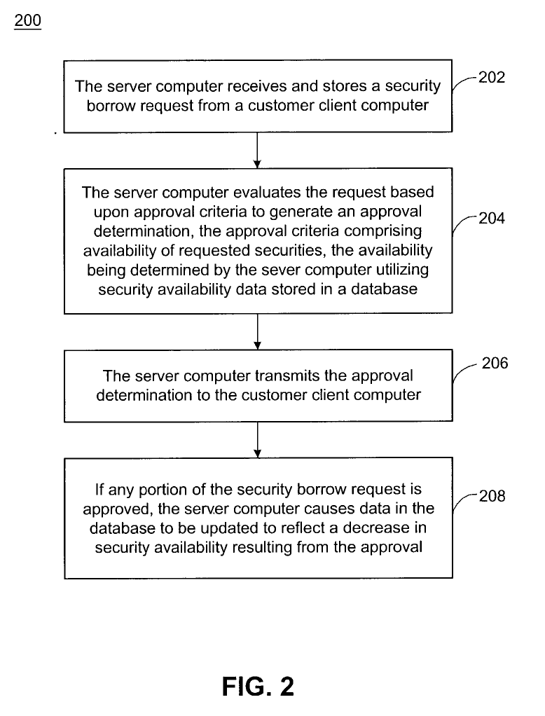

FIG. 2 is a flow diagram of a method 200 for facilitating securities borrowing transactions, according to one embodiment of the invention. In this embodiment of the invention, a trading desk computer is not provided. At step 202 the server computer 116 receives and stores a security borrow request from the customer client computer 106. The following example is provided for illustrative purposes. An investor may offer to purchase 100 shares of XYZ stock from the investor's broker at a present trading price of $100 per share. The broker may wish to enter into this transaction, believing that the price of XYZ stock will decline in the future. Not having the 100 shares on hand, the broker may desire to request to borrow the 100 shares from a company, with which to settle the transaction with the investor. Later, the broker hopes to purchase 100 shares of XYZ stock at a lower price than $100 per share, so that the investor may potentially make a profit, even after deducting the broker's expenses, including interest charged by the company for the loan of the 100 shares.

The broker, working at the customer client computer 106, and utilizing an application provided by the ASAP client program 112, may submit a securities borrow request through the Internet 104 and through the firewall 114 to the server computer 116, the server computer 116, and the computer system 102 of which it is a part, being associated with the company. Advantageously, the ASAP client program 112 allows for annotation of the request. For example, the broker may send the message “any you can find” with the security borrow request. The request may be submitted securely, for example, in part, by requiring that the broker enter a user name and password before submitting the request. Of course, other forms of security known in the art are possible. The broker's request is then received and stored by the server computer at step 202.

At step 204, the server computer 116, according to one embodiment of the ASAP server program 122, evaluates the request based upon approval criteria to generate an approval determination. The approval criteria comprise the availability of the requested securities, with the availability determined by the server computer utilizing security availability data stored in a database.

The server computer 116 may also determine a rate of interest to be applicable to an approved request. The rate of interest may be determined in various ways, including, for example, a standard rate determined from data accessed by the server computer 116, or particular rates represented by stored data accessible by the server computer 116.

To continue the illustrative example from above, the server computer 116 receives and stores the broker's request to borrow 100 shares of XYZ stock. The securities database 131 of the database server computer 126 contains data to indicate the securities that the company has available to fulfill the borrow request. In accordance with the ASAP server program 122, the server computer 116 accesses the securities database 131 of the database server computer 126 to obtain data to indicate whether the company has 100 shares of XYZ securities available to fulfill the borrow request, or, if 100 shares are not available, how many shares, if any, are available to partially fulfill the request.

The availability of the requested securities is one criteria, and, in some embodiments of the invention, the only criteria that the server computer 116, according to the ASAP server program 122, utilizes in making an approval determination. However, in some embodiments of the invention, the ASAP computer program 116 causes the determination to be made based on various other criteria as well. Some criteria may depend upon the particular broker or other requester. Data regarding criteria may be stored in the securities database 131, the data storage device 120 of the server computer 116, or elsewhere, and may be updated frequently or on a real time basis. Some examples of additional criteria include marginability, corporate action activity, whether the quantity of requested shares is within a specified range, whether the current price the requested shares are within a specified range, whether the requested securities are on a specified lending list, and various other criteria are possible. In some embodiments of the invention, the ASAP server program 122 causes the server computer to verify that the request does not fit a specified pattern which may suggest fraud or some other problem, such as too frequent requesting by a particular requestor or for a particular stock. Based on the criteria, the server computer 116, according to the ASAP server program 122, may determine whether the request is approved, approved in part, or rejected.

At step 206, the server computer 116, according to the ASAP server program, transmits the approval determination to the customer client computer 106. The rate of interest applicable to an approved request is also transmitted to client computer 106 at this time. The approval determination may include approved, partial, pending or rejected status. Approved status indicates that the entire securities borrow request has been approved. Partial status indicates that a portion of the securities borrow request has been approved. A pending status refers to a security that is not on a specified lending list but may be possible to locate. This status therefore reflects an open order that may be filled. A rejected status indicates that the entire order is rejected, as the security cannot be located. To continue the illustrative example above, the server computer may determine that a loan of only 50 of the 100 requested shares of XYZ stock is approved, with the remaining 50 shares requested being rejected. The server computer transmits this approval determination to the customer client computer 112 where, through the ASAP client program, the broker may learn of the determination, and proceed accordingly with regard to the proposed transaction by the investor.

Finally, at step 208, if any portion of the security borrow request is approved, the server computer, through the ASAP server program, causes data in the database to be updated to reflect a decrease in securities availability resulting from the approval. The server computer may transmit an instruction to the database server computer 126 to cause the data in the securities database to be updated to reflect a decrease of 50 shares of available XYZ stock. In some embodiments of the invention, the database server computer 126 is not provided, and the securities database may be located, for example, in the data storage device 120 of the server computer, so that the updating of the data can be accomplished internally by the server computer 116. The updates are transmitted to customer client computer 112 for review by the broker.

Advantageously, the ASAP server program accommodates multiple brokers, and provides related updates to all brokers associated with a customer client. Each broker working for a customer client will receive all updates associated with the customer client as well as any other status changes executed by the system.

The entire sequence described in FIG. 2 may take place completely automatically, in that it no human action or judgement may be required to accept the borrow request, make an approval determination, and send a message to indicate the approval determination. Hence, given the speed of computer processing, the broker may be able to submit a request at any time and receive an approval determination almost immediately, conveniently enabling the broker to quickly accept the offer proposed by the investor. In addition, the company needs to expend minimal resources in processing the request, which may allow the company to offer a low interest rate to the broker on the securities lend, further attracting the broker's business.

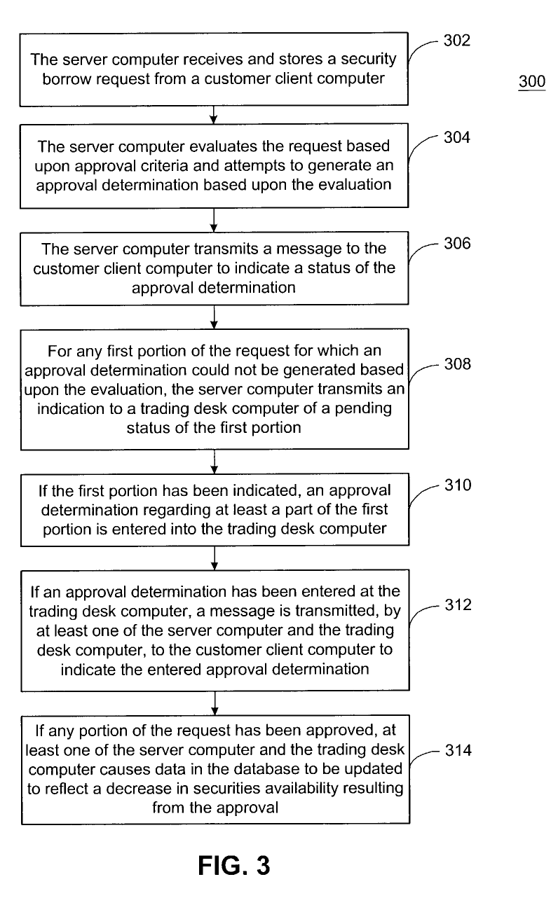

FIG. 3 is a flow diagram of a method 300 for facilitating securities borrowing transactions, according to another embodiment of the invention. In the embodiment of the invention described with reference to FIG. 3, a trading desk computer is incorporated into the method 300. In some embodiments of the invention, the trading desk computer 118 allows human determinations to be made regarding borrow requests which cannot be approved or disapproved automatically by the server computer 116 according to the ASAP server program 122 and utilizing accessed stored data. Thus, the embodiment described with reference to FIG. 3 may permit automatic, nearly immediate approval determinations to be made when circumstances warrant it, while preserving the option for human decision-making where appropriate.

At step 302, the server computer 116 receives and stores a security borrow request from the customer client computer 106. At step 304, the server computer 116 evaluates the request based upon approval criteria and attempts to generate an approval determination based upon the evaluation. In this instance, allowance is made for the situation in which a certain set of criteria cause the server computer to be unable to make an approval determination regarding a borrow request or a portion thereof. As one example, if a particular requested stock is not on a specified lending list, the ASAP server program 122 may cause the server computer 116 to make a determination of, for example, pending, indicating that neither an approval nor rejection may be determined for the borrow request or a portion thereof.

At step 306, the server computer transmits a message to the customer client computer 106 to indicate a status of the approval determination. For example, the server computer 116 may determine that a request has an approval determination status of approved, rejected, or pending, and indicate the status to the customer client computer 106. In some instances, a partial status may be indicated, such as, for example, if a borrow request for 100 shares of XYZ stock results in an approval determination of approved for 50 shares, rejected for 25 shares, and pending for 25 shares. The evaluation and approval determination criteria may vary widely, and may be set, for example, by a company managing the server computer 116 and actually making the security loan. In some embodiments of the invention, such criteria and ASAP server program 112 operating parameters generally may be set by a system administrator through an application programming interface (API) supplied by the ASAP server program 122, or the ASAP server program may be configured or set up in other ways. In some embodiments of the invention, the server computer 116 relays all received securities borrow requests and approval determinations to the trading desk computer 118.

At step 308, for any first portion of the borrow request for which an approval determination can not be generated based on the evaluation, the server computer 116 transmits an indication to the trading desk computer 118 of a pending status of the first portion. To continue the example described above with regard to step 306, the server computer 116 would send an indication to the trading desk computer of the fact that 25 shares of the requested shares have a pending status.

At step 310, if a first portion has been indicated, i.e., if any portion of the borrow request has received a pending status by the server computer 116, an approval determination regarding at least part of the first portion is entered into the trading desk computer 118. To continue the illustrative example described above with regard to step 308, a decision-maker, such as a trader or broker, working at the trading desk computer 118 may access the pending status of the 25 shares of the borrow request. The decision-maker can then personally evaluate the particular circumstances surrounding the borrow request and make a manual approval determination, such as rejected or approved, which approval determination the decision-maker then enters into the trading desk client computer, to be stored in the data storage device 123. For example, the decision-maker may decide to make an approval determination of rejected for the 25 requested shares previously having pending status. In addition, the decision-maker may annotate the approval determination transmitted to customer client computer 106 to advise, for example, of a security status. By way of illustration, the decision-maker may note that a particular security “is getting difficult to borrow” or that a “bid rate” is offered.

At step 312, if an approval determination has been entered at step 310, the approval determination is transmitted by at least one of the server computer 116 and the trading desk computer 118 to the customer client computer 106, be to stored in the data storage device 110. For example, in the illustrative example described above with regard to step 310, the server computer 116 communicates the status change from pending to rejected, according to the entered approval determination. The requestor may then access this status change.

At step 314, if any portion of the request has been approved, at least one of the server computer 116 and the trading desk computer 118 causes data in the securities database 131 to be updated to reflect a decrease in security availability resulting from the approval. To continue the illustrative example described above regarding step 312, the server computer 116 sends an instruction to the securities database 131 to update the data to reflect a decrease of 50 shares of available XYZ stock, since 50 shares of the 100 requested shares of XYZ stock were ultimately approved.

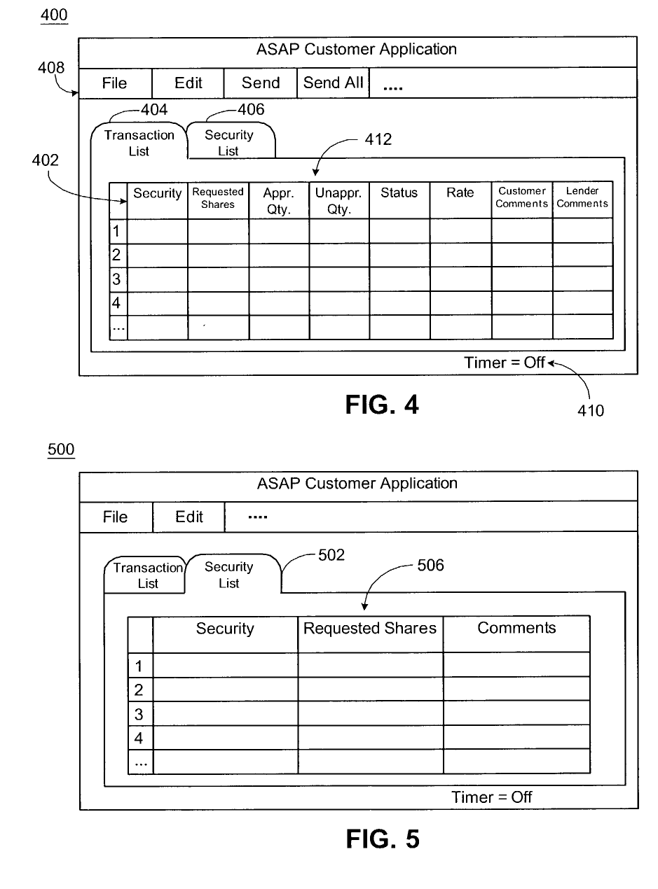

FIGS. 4-6 depict graphical user interfaces (GUIs) of an ASAP customer application according to one embodiment of the invention. The ASAP customer application may be provided by the ASAP client program 112 to run on the customer client computer 106. Generally, the ASAP customer application provides a spreadsheet-style interface through which requestors can formulate, manipulate, and send specific borrow requests. Transaction lists may be utilized to prepare specific sets of requests, which can then be sent to the server computer 116 for approval determination. Security lists are similar to transaction lists, but are utilized to prepare and record lists of requests which may be accessed later, such as by being selected to populate a transaction list spreadsheet.

FIG. 4 is a simplified depiction of a GUI 400 displayed on a customer client computer 106 according to one embodiment of the invention, in which a transaction list 404 is shown. In the GUI 400, a tabbed electronic “file” labeled “Transaction List” 404 is shown in the foreground, and a tabbed electronic “file” labeled “Security List” 406 is shown in the background. Within the transaction list 404, a spreadsheet 412 is provided. The spreadsheet comprises columns 402, including columns for the following information: security, requested shares, approved quantity, unapproved quantity, status, rate, customer comments, and lender comments. A number of selectable buttons are provided in a menu bar 408, including print, send, and send all. The transaction list 404 may be used by requestors to set up a set of securities borrow requests, in which each utilized row constitutes a borrow request for a certain number of shares of a specified security. For a request to be ready for sending, the requester must fill in, for the row, the security field and the requested shares field. In various embodiments of the invention, pop-up menus and other tools may be used to assist requesters in filling in various fields.

When ready, the requestor can transmit one or more borrow requests to the server computer 116 by, for example, clicking on the send button. The sender may select multiple requests to be sent simultaneously by specifying specific rows, for example by pointing and clicking with a pointing device to highlight certain rows. Alternatively, the sender may elect to send all utilized rows in the transaction list, by utilizing the “Send All” button.

A timer 410 is shown at the bottom if the GUI 400. In some embodiments of the invention, the requester may set a timer function to cause a specified set of requests to be sent at a specified time.

In the embodiment depicted in FIG. 4, the various fields are filled in, if at all, by messages sent from the server computer 116 or the trading desk computer 118. For example, in some embodiments, the approved quantity, unapproved quantity, status and rate fields may be determined by the server computer 116 and transmitted to the customer client computer 106 be displayed on the spreadsheet 412. In some embodiments, lender comments may be entered at the trading desk computer 118 to be transmitted to the customer client computer 106 and displayed on the spreadsheet 412.

In some embodiments of the invention, the spreadsheet 412 data may be manipulated by various well-known functions, such as by being sorted, printed, stored in customer client computer 106 and the like.

FIG. 5 is a simplified depiction of a GUI 500 displayed on the customer client computer 116 according to one embodiment of the invention, in which a security list 502 is shown in the foreground. The security list 502 comprises a spreadsheet 506 having the following columns: security, requested shares, and comments. Requestors may use security lists to enter sets of requests to be saved and accessed later. For example, particular securities lists may be utilized later to be selected to populate a transaction list spreadsheet, from which certain or all of the requests may be edited or sent to the server computer 116 for approval determination. In some embodiments of the invention, a requestor may utilize the timer function described above to cause a particular set of requests specified by a security list to be automatically sent at a certain time.

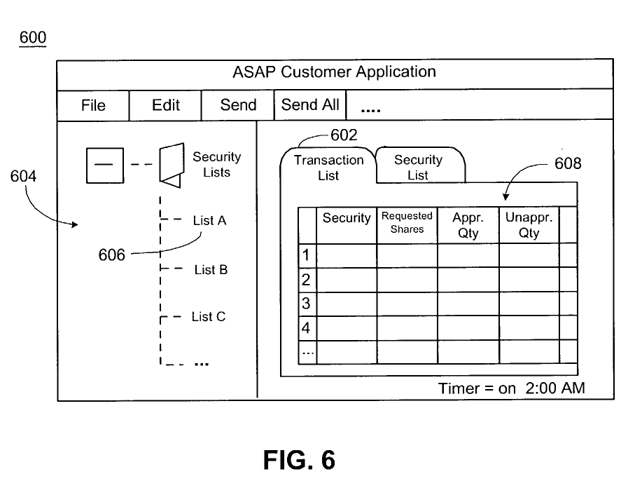

FIG. 6 is a simplified graphical user interface 600 displayed on a customer client computer 116 according to one embodiment of the invention, in which a transaction list 602 and a security list file tree 604 are shown in the foreground. By selecting a particular security list, such as List A 606, a requestor can cause the requests specified in the security list to populate the transaction list spreadsheet 608, from which the requests may be edited, manipulated, and sent to the server computer 116 for approval determination.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A networked computer system for facilitating transactions, the transactions comprising borrowing of securities, the system comprising:
a database containing securities availability data;
a client computer; and
a server computer, wherein the server computer:
receives a securities borrow request transmitted by the client computer;
evaluates the borrow request based upon approval criteria, the approval criteria comprising availability of the requested securities, the availability being determined by the server computer utilizing the securities availability data;
generates, based upon the evaluation, an approval determination;
transmits to the client computer an indication of the generated approval determination; and
if any portion of the securities borrow request is determined to be approved, causes the securities availability data in the database to be updated to reflect a decrease in securities availability resulting from the approval.

2. The system of claim 1, wherein the approval determination is automatically generated.

3. The system of claim 1, wherein the securities borrow request is transmitted securely.

4. The system of claim 1, wherein the securities borrow request is entered into the client computer by a broker before the securities borrow request is transmitted to the server computer.

5. The system of claim 1, wherein the securities borrow request is to facilitate an anticipated short sale transaction.

6. A networked computer system for facilitating transactions, the transactions comprising borrowing of securities, the system comprising:
a database containing securities availability data;
a client computer;
a trading computer; and
a server computer, wherein the server computer:
receives a securities borrow request transmitted by the client computer;
evaluates the securities borrow request based upon approval criteria, the approval criteria comprising availability of the requested securities, the availability being determined by the server computer utilizing the securities availability data;
if possible based upon the evaluation, generates an approval determination;
transmits to the client computer an indication of a status of the approval determination;
if the approval determination could not be generated for a first portion of the securities borrow request based upon the approval criteria, transmits an indication to the trading computer of a pending status of the first portion, and receives from the trading computer a trading computer approval determination relating to the first portion, the trading computer approval determination having been entered into the trading computer; and
if any portion of the securities borrow request is determined to be approved, causes the securities availability data in the database to be updated to reflect a decrease in securities availability resulting from the approval.

7. The system of claim 6, wherein the approval determination by the server computer is automatically generated.

8. The system of claim 6, wherein the trading computer approval determination is a manual determination.

9. The system of claim 6, wherein the securities borrow request is transmitted securely.

10. The system of claim 6, wherein the securities borrow request is entered into the client computer by a broker before the securities borrow request is transmitted to the server computer.

11. The system of claim 6, wherein the securities borrow request is to facilitate an anticipated short sale transaction.

12. The system of claim 6, wherein the server computer determines, for any approved request, based on interest rate criteria, an applicable interest rate, and wherein the interest rate is transmitted to the client computer.

13. The system of claim 6, wherein the securities borrow request is formulated on the client computer by a user utilizing a spreadsheet-based application.

14. The system of claim 13, wherein the spreadsheet-based application allows the user to store specific sets of securities borrow request information for later use through the application.

15. The system of claim 14, wherein the spreadsheet-based application allows the user to transmit selected sets of securities borrow requests to the server computer.

16. The system of claim 15, wherein the spreadsheet-based application allows the user to set an electronic timer to cause a selected set of securities borrow requests to be transmitted at a selected time to the server computer.

17. In a networked computer system comprising a server computer and a client computer, a method for facilitating transactions, the transactions comprising borrowing of securities, the method comprising:
the client computer transmitting a securities borrow request to the server computer;
the server computer receiving the securities borrow request and evaluating the securities borrow request based upon approval criteria, the approval criteria comprising availability of the requested securities, the availability being determined by the server computer utilizing securities availability data contained in a database accessed by the server computer;
the server computer generating, based upon the evaluation, an approval determination;
the server computer transmitting to the client computer an indication of the generated approval determination; and
if any portion of the securities borrow request is determined to be approved, the server computer causing the securities availability data in the database to be updated to reflect a decrease in securities availability resulting from the approval.

18. The method of claim 17, wherein the approval determination is automatically generated.

19. The method of claim 17, wherein the securities borrow request is transmitted securely.

20. The system of claim 17, wherein the securities borrow request is entered into the client computer by a broker before the securities borrow request is transmitted to the server computer.

21. The system of claim 17, wherein the securities borrow request is to facilitate an anticipated short sale transaction.

22. In a networked computer system comprising a server computer, a client computer, and a trading computer, a method for facilitating transactions, the transactions comprising borrowing of securities, the method comprising:
the client computer transmitting a securities borrow request to the server computer;
the server computer receiving the securities borrow request and evaluating the securities borrow request based upon approval criteria, the approval criteria comprising availability of the requested securities, the availability being determined by the server computer utilizing securities availability data contained in a database accessed by the server computer;
if possible based upon the evaluation, the server computer generating an approval determination;
the server computer transmitting to the client computer an indication of a status of the approval determination;
if the approval determination could not be generated for a first portion of the securities borrow request based upon the approval criteria, the server computer transmitting an indication to the trading computer of a pending status of the first portion, and receiving from the trading computer a trading computer approval determination regarding the first portion, the trading computer approval determination having been entered into the trading computer; and
if any portion of the securities borrow request is determined to be approved, the server computer causing the securities availability data in the database to be updated to reflect a decrease in securities availability resulting from the approval.

23. The method of claim 22, wherein the approval determination by the server computer is automatically generated.

24. The method of claim 22, wherein the trading computer approval determination is a manual determination.

25. The method of claim 22, wherein the securities borrow request is transmitted securely.

26. The method of claim 22, wherein the securities borrow request is entered into the client computer by a broker before the securities borrow request is transmitted to the server computer.

27. The method of claim 22, wherein the securities borrow request is to facilitate an anticipated short sale transaction.

28. The method of claim 22, wherein the server computer determines, for any approved securities borrow request, based on stored interest rate criteria, an applicable interest rate, and wherein the interest rate is transmitted to the client computer.

29. The method of claim 22, wherein the securities borrow request is formulated on the client computer by a user utilizing a spreadsheet-based application.

30. The method of claim 29, wherein the spreadsheet-based application allows the user to store specific sets of securities borrow request information for later use through the application.

31. The method of claim 30, wherein the spreadsheet-based application allows the user to transmit selected sets of securities borrow requests to the server computer.

32. The method of claim 31, wherein the spreadsheet-based application allows the user to set an electronic timer to cause a selected set of securities borrow requests to be transmitted at a selected time to the server computer.

33. A computer usable medium storing program code which, when executed on a computerized device, causes the computerized device to execute, in a networked computer system comprising a server computer, a client computer, and a trading computer, a method for facilitating transactions, the transactions comprising borrowing of securities, the method comprising:
the client computer transmitting a securities borrow request to the server computer;
the server computer receiving the securities borrow request and evaluating the securities borrow request based upon approval criteria, the approval criteria comprising availability of the requested securities, the availability being determined by the server computer utilizing securities availability data contained in a database accessed by the server computer;
if possible based upon the evaluation, the server computer generating an approval determination;
the server computer transmitting to the client computer an indication of a status of the approval determination;
if the approval determination could not be generated for a first portion of the securities borrow request based upon the approval criteria, the server computer transmitting an indication to the trading computer of a pending status of the first portion, and receiving from the trading computer a trading computer approval determination, the trading computer approval determination having been entered into the trading computer; and
if any portion of the securities borrow request is determined to be approved, the server computer causing the securities availability data in the database to be updated to reflect a decrease in securities availability resulting from the approval.
